(19) United States
(12) Patent Application Publication
(10) Pub. No.: US 2011/0000890 A1
(43) Pub. Date: Jan. 6, 2011

(54) Potential-Free Wire Heating During Welding and Apparatus Therefor

(76) Inventors: Nikolai Arjakine, Berlin (DE); Rolf Wilkenhöner, Kleinmachnow (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/919,814

(22) PCT Filed: Jan. 13, 2009
(86) PCT No.: PCT/EP2009/050310

§ 371 Date: Aug. 27, 2010

(30) Foreign Application Priority Data
Feb. 29, 2008 (EP) 08003814.4

(51) Int. Cl. B23K 9/16; B23K 9/10; B23K 10/02; B23K 26/00

(52) U.S. Cl. 219/75; 219/130.1; 219/121.46; 219/121.64

(57) ABSTRACT

In conventional hot wire welding, the deposition rate and temperature cannot be adjusted. A process for welding a component in which a heated welding wire is fed to the component is provided. Through the potential-free heating of the welding wire, the deposition rate and temperature may be further increased. A welding apparatus is also provided.

The invention relates to welding wire heating during welding according to the preamble of claim 1 and to the corresponding apparatus according to the preamble of claim 4.

In the production of components subject to heat in gas turbines, it is often the case that only the Ni-based superalloys are taken into consideration. Ni-based superalloys with a high y′ phase content are used for those gas turbine parts which are subject to the highest stresses by the aggressive hot-gas medium, for example guide vanes and rotor blades of the first stages, guide ring segments and the parts of the annular combustion chamber. The high y′ content ensures a high strength in the high-temperature range, since particle hardening is made possible with very high proportions by volume of the coherent y′ phase Ni3 (Al—Ti,Ta,Nb). Despite the very good material properties of the Ni-based superalloys, the hot-gas components often have some damage after a certain number of operating hours, and this has to be repaired during refurbishment. This damage is caused by very high thermal and mechanical loading. In addition, the surrounding gas atmosphere is very corrosive. In general, all Ni-based superalloys having a higher y′ content can be considered weldable only to a limited extent, since they are firstly very sensitive to hot cracking in the heat-affected zone during welding and secondly experience the phenomenon of post-weld heat treatment cracking, which is caused by local precipitation phenomena of the y′ phase.

The disadvantage of conventional hot wire heating consists in the low melting capacity and possible heat-related adjustability of the temperature of the welding wire and therefore the maximum possible temperature of the welding wire.

It is therefore an object of the invention to specify a process and an apparatus which overcome the above-mentioned problem.

The object is achieved by a process as claimed in claim 1 and by an apparatus as claimed in claim 4.

The dependent claims list further advantageous measures which can advantageously be combined with one another in any desired manner.

Repairs to gas turbine blades or vanes have major economic benefits, since the components are very expensive. Manual TIG welding is preferably employed as standard process for repairing the hot-gas components subjected to operational stresses. Joint welds or deposition welds produced by TIG welding have a relatively high quality. In addition, this process is easy to carry out. To date, the use of promising beam processes and also laser and electron beam processes has been limited primarily to two-dimensional contours owing to a limited flexibility. However, it is also often necessary to carry out repair welds in regions with a complicated geometry, and this limits the use of laser and electron beam processes. Manual TIG welding is frequently used, as a flexible process, for the weld repair of hot-gas components of a gas turbine subjected to operational stresses. Compared to other processes, it affords the significant advantage of an outstanding seam quality, even during welding in pressing situations. The disadvantages lie in the low melting capacity and in the associated long welding time, and also in the reliance on the manual skill of the welder. A further significant disadvantage of TIG welding, in general terms, is the tendency toward hot cracking of the Ni-based and Co-based alloys, amplified by the high level of heat introduced during TIG welding.

Welding with preheated fillers, in particular with preheated wires, is prior art. However, the aim here is exclusively to increase the efficiency of the process by increasing the melting rate of the filler and thereby also the welding rate. The aim of the present invention is to reduce the cracking of the Ni superalloys by reducing the level of heat introduced into the substrate. It is advantageously also possible to use existing wire preheating systems for those wire thicknesses which are usually used for the TIG welding of Ni superalloys (≦2 mm diameter, in particular 1 mm). The exact parameters of a suitable wire preheating system for the TIG welding of Ni superalloys are specified individually. The use of the proposed welding technology makes it possible to reduce the level of heat introduced during the TIG welding of Ni-based and Co-based superalloys and thus to reduce the susceptibility to hot cracking and/or to increase the productivity of the TIG welding process.

However, the invention is not restricted to TIG welding, but instead can be employed for all welding processes which operate using filler in wire form (i.e. for example plasma wire welding, laser wire welding).

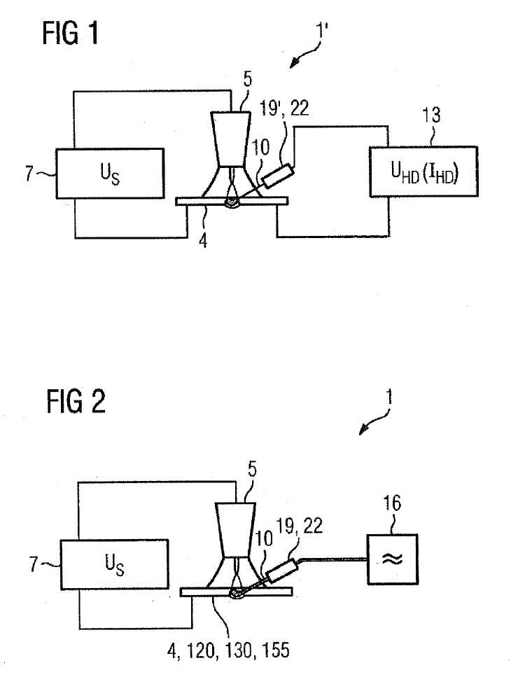

FIG. 1 shows an apparatus for conventional hot wire welding,

FIG. 2 shows an apparatus for potential-free welding,

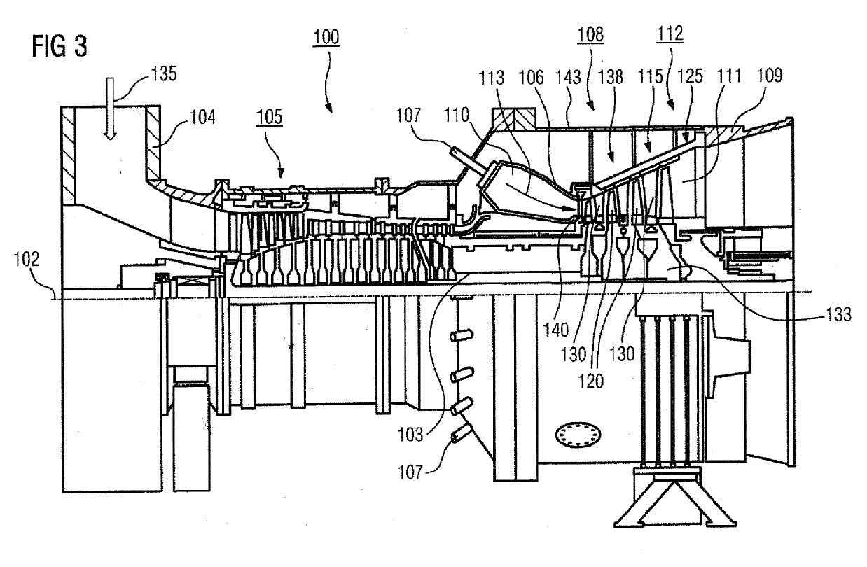

FIG. 3 shows a gas turbine,

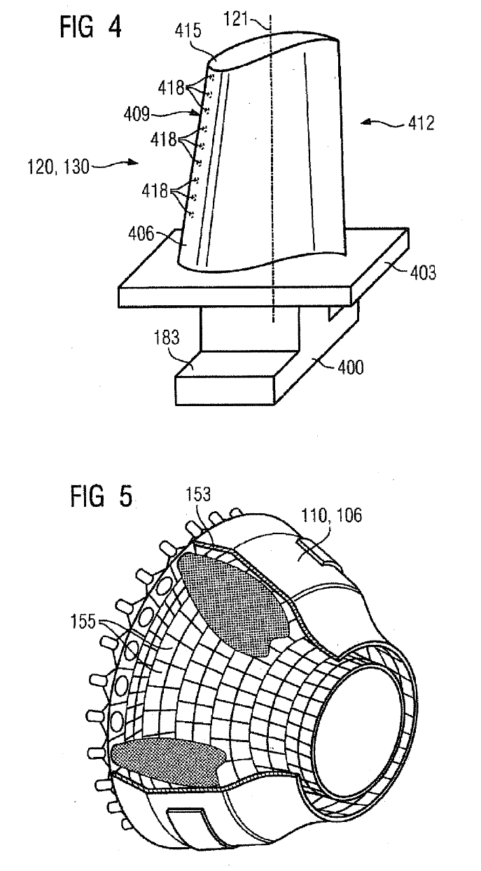

FIG. 4 shows a perspective view of a turbine blade or vane,

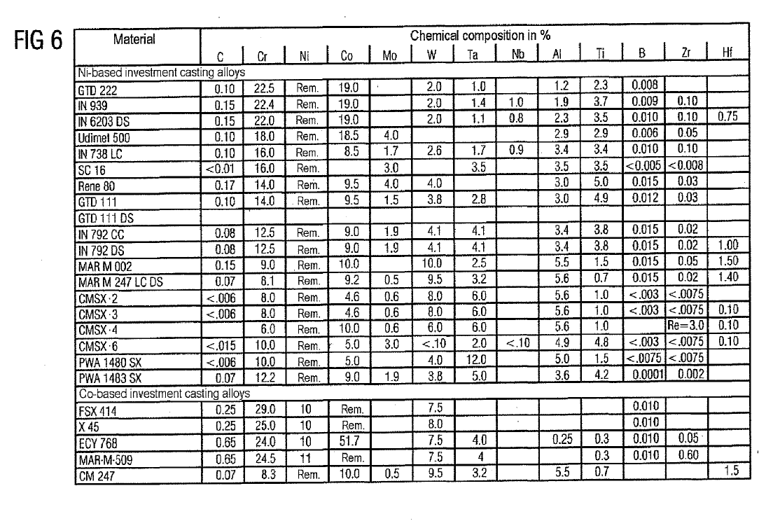

FIG. 5 shows a perspective view of a combustion chamber, and

FIG. 6 shows a list of superalloys.

The figures and the description merely represent exemplary embodiments of the invention.

FIG. 1 schematically shows an apparatus 1′ for conventional hot welding wire filling during welding.

For a component 4 to be welded, the apparatus 1 has a heat generator 7 for the component 4 and a wire feed 22, which feeds the welding wire 10 to that location of the component 4 to be welded, a welding unit 5 and a heater 19′. There is also a voltage source 13, which preheats the welding wire 10, said voltage source 13 being electrically connected to the substrate 4.

An increase in the temperature of the welding wire 10 therefore inevitably results in an undesirable increase in the temperature of the component 4.

The heating of the welding wire 10 and the heating of the component 4, 120, 130, 155 are therefore not thermally decoupled from one another. This limits the maximum temperature of the welding wire 10.

By contrast, FIG. 2 shows an apparatus 1 according to the invention with potential-free wire heating, in which there is no longer an electrical connection between the heater 19 of the welding wire 10 and the component 4, 120, 130, 155 (FIGS. 4, 5).

The heater 19 is preferably an alternating current source. Similarly, the welding wire 10 can also preferably be heated inductively.

The welding wire 10 can thus be heated to much higher temperatures of 400° C. to 1050° C.

It is also possible to influence the melting viscosity of the welding wire 10. The welding wire 10 has a diameter of up to 2 mm.

Furthermore, the level of heat introduced into the component 4, 120, 130, 155 is reduced and the susceptibility to hot cracking is thereby reduced.

The welding process otherwise proceeds as per the prior art, e.g. for plasma wire welding, laser wire welding or TIG welding.

The component 4, 120, 130, 155 can likewise be heated by a heat generator 7.

Components 4, 120, 130, 155 are preferably made of Rene80, Inconel 738 LC, Inconel 939, PWA1483SX, Siemet DS, IN6203DS, Alloy 247 or an alloy as shown in FIG. 5.

FIG. 3 shows, by way of example, a partial longitudinal section through a gas turbine 100.

In the interior, the gas turbine 100 has a rotor 103 with a shaft 101 which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they may be cooled by means of a coolant.

Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949.

The blades or vanes 120, 130 may likewise have coatings protecting against corrosion (MCrAlX; M is at least one element selected from the group consisting of iron (Fe), cobalt (Co), nickel (Ni), X is an active element and stands for yttrium (Y) and/or silicon, scandium (Sc) and/or at least one rare earth element, or

hafnium). Alloys of this type are known from EP 0 486 489 B1, EP 0 786 017 B1, EP 0 412 397 B1 or EP 1 306 454 A1.

It is also possible for a thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide. Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

FIG. 4 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries,

which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density. A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX. The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

FIG. 5 shows a combustion chamber 110 of the gas turbine 100. The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 B1, EP 0 412 397 B1 or EP 1 306 454 A1, which are intended to form part of this disclosure with regard to the chemical composition of the alloy.

It is also possible for a, for example, ceramic thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks.

Refurbishment means that after they have been used, protective layers may have to be removed from turbine blades or vanes 120, 130 or heat shield elements 155 (e.g. by sand-blasting). Then, the corrosion and/or oxidation layers and products are removed. If appropriate, cracks in the turbine blade or vane 120, 130 or in the heat shield element 155 are also repaired. This is followed by recoating of the turbine blades or vanes 120, 130 or heat shield elements 155, after which the turbine blades or vanes 120, 130 or the heat shield elements 155 can be reused.

1-9. (canceled)

10. A process for welding a component, comprising:
feeding a heated welding wire to the component; and
heating the welding wire in a potential-free manner using an alternating current source or inductively, and
wherein there is no electrical connection between the welding wire and the component.

11. The process as claimed in claim 10, wherein the process is used during plasma wire welding, laser wire welding or tungsten inert gas welding.

12. A welding apparatus, comprising:
a welding unit; and
a wire feed for a welding wire,
wherein the welding wire may be heated in a potential-free manner.

13. The welding apparatus as claimed in claim 12, wherein a heater for the potential-free heating of the welding wire is present.

14. The welding apparatus as claimed in claim 12, wherein an alternating current source is present as the heater for the potential-free heating of the welding wire.

15. The welding apparatus as claimed in claim 12, wherein an induction source is present as the heater for the potential-free heating of the welding wire.

16. The welding apparatus as claimed in claim 12, wherein a heat generator for heating the component is present.

17. The welding apparatus as claimed in claim 12, wherein the welding wire includes a diameter of up to 2 mm.
